(19) United States
(12) Patent Application Publication
(10) Pub. No.: US 2012/0182895 A1
(43) Pub. Date: Jul. 19, 2012

(54) APPARATUS AND METHOD FOR TRANSMITTING AND RECEIVING CHANNEL STATE INFORMATION

(75) Inventor: Hye Kyung JWA, Daejeon (KR)

(73) Assignee: Electronics and Telecommunications Research Institute, Daejeon (KR)

(21) Appl. No.: 13/350,589

(22) Filed: Jan. 13, 2012

(30) Foreign Application Priority Data
Jan. 13, 2011 (KR) 10-2011-0003725
Apr. 5, 2011 (KR) 10-2011-0031366

(51) Int. Cl. H04W 72/04; H04W 24/00

(52) U.S. Cl. 370/252; 370/329

(57) ABSTRACT

Provided are apparatus and a method for transmitting and receiving channel state information. The apparatus for transmitting channel state information includes a resource demapper configured to extract at least one of data, a user equipment (UE)-specific reference signal, and a cell-specific reference signal from an orthogonal frequency division multiplexing (OFDM)-demodulated signal, a channel estimation unit configured to estimate a downlink channel on the basis of at least one of the UE-specific reference signal and the cell-specific reference signal, and a channel state information producer configured to produce at least one of a cell-specific channel quality indicator (CQI), a UE-specific CQI, and switched beam selection information on the basis of information on the estimated downlink channel. Accordingly, it is possible to efficiently perform channel adaptive transmission and beamforming-mode transmission in consideration of an actually reflected beamforming gain and interference cancellation gain.

### CLAIM FOR PRIORITY

This application claims priority to Korean Patent Application No. 2011-0003725 filed on Jan. 13, 2011 and No. 2011-0031366 filed on Apr. 5, 2011 in the Korean Intellectual Property Office (KIPO), the entire contents of which are hereby incorporated by reference.

### BACKGROUND

1. Technical Field

Example embodiments of the present invention relate in general to a wireless communication system, and more particularly, to apparatus and a method for transmitting and receiving channel state information in a wireless communication system.

2. Related Art

Multiple input multiple output (MIMO) technology for increasing system capacity in a wireless communication system has been adopted in communication systems employing orthogonal frequency division multiple access (OFDMA) technology, and developed in various forms.

In the MIMO technology, a plurality of transmitter and/or receiver antennas are used to transmit a signal. The MIMO technology can be generally divided into transmit diversity, spatial multiplexing, and beamforming techniques, all of which have been reflected in Third Generation Partnership Project (3GPP) Long Term Evolution (LTE). Also, closed-loop MIMO technology using channel state information has been applied to further improve the capacity of a wireless communication system.

When a wireless communication system operates in a beamforming mode, a base station has an array antenna in which a distance between antennas is generally 0.5λ (λ denotes a wavelength), and transmits data and a reference signal to a user equipment (UE) after applying a beamforming weight vector to the data and reference signal. In the beamforming mode, a beamforming gain can be basically obtained, and in a dual-layer beamforming mode reflected in LTE release-9, it is possible to reduce interference caused by a signal of another UE allocated to the same frequency and time resources.

The beamforming weight vector can be calculated using eigen decomposition of a channel covariance matrix or an array response vector. In these methods, the beamforming weight vector can be calculated only when the base station has mode channel state information.

In a wireless communication system using a frequency division duplex (FDD) scheme, an uplink and downlink generally have different frequency bands, and thus a base station needs to receive the feedback of channel state information on the downlink from a UE. Meanwhile, in a wireless communication system using a time division duplex (TDD) scheme, an uplink and downlink have the same frequency band. Thus, assuming that the uplink and downlink have the same channel state, a channel state of the downlink is estimated using a measurement reference signal (sounding reference signal) of the uplink, etc., and then a beamforming weight vector is calculated using information on the estimated channel state. However, the uplink and downlink may have different channel states according to whether or not antennas are calibrated.

Currently, only a channel quality indicator (CQI) exists as channel state information in downlink transmission mode 7 that is a beamforming mode of LTE release-8, and information whereby a beamforming weight vector can be calculated is not included. Here, the CQI is calculated using a cell-specific reference signal in a UE on the assumption that a transmission mode is a transmit diversity mode, and thus a base station should estimate a beamforming gain to perform channel adaptive transmission.

Also, downlink transmission mode 8 that is a dual-layer beamforming mode reflected in LTE release-9 is classified as a mode in which only a CQI is transmitted or a mode in which a CQI and precoding matrix index (PMI) are transmitted, according to the configuration of an upper layer. In the mode in which only a CQI is transmitted, the CQI is fed back in the same way as in downlink transmission mode 7 of LTE release-8, and thus the above-mentioned drawback is included. On the other hand, in the mode in which a CQI and PMI are transmitted, a PMI having the best signal-to-noise ratio (SNR) is selected from precoding matrices defined in 3GPP TS 36.211, and a CQI corresponding to a case in which the selected PMI is applied is calculated and fed back. Thus, an actual beamforming gain is not reflected.

### SUMMARY

Accordingly, example embodiments of the present invention are provided to substantially obviate one or more problems due to limitations and disadvantages of the related art.

Example embodiments of the present invention provide channel state information transmitting and receiving apparatus that can obtain information required to transmit data in a beamforming mode and enable efficient performance of channel adaptive transmission.

Example embodiments of the present invention also provide a channel state information transmitting and receiving method of the channel state information transmitting and receiving apparatus.

In some example embodiments, an apparatus for transmitting channel state information includes: an orthogonal frequency division multiplexing (OFDM) demodulation unit configured to perform OFDM demodulation on a received signal; a resource demapper configured to extract at least one of data, a user equipment (UE)-specific reference signal, and a cell-specific reference signal from the OFDM-demodulated signal; a channel estimation unit configured to estimate a downlink channel on the basis of at least one of the UE-specific reference signal and the cell-specific reference signal; and a channel state information producer configured to produce at least one of a cell-specific channel quality indicator (CQI), a UE-specific CQI, and switched beam selection information on the basis of information on the estimated downlink channel.

The channel estimation unit may include: a UE-specific channel estimator configured to provide the channel estimation unit with UE-specific channel estimation results obtained by estimating the downlink channel on the basis of the UE-specific reference signal; and a cell-specific channel estimator configured to provide the channel estimation unit with cell-specific channel estimation results obtained by estimating the downlink channel on the basis of the cell-specific reference signal.

When it becomes time to calculate a CQI, the channel state information producer may calculate a signal-to-noise ratio (SNR) of the received signal using the cell-specific channel estimation results, and convert the calculated SNR into a predetermined number of CQI bits to calculate the cell-specific CQI.

When it becomes time to calculate a CQI, the channel state information producer may calculate an SNR of the received signal using the UE-specific channel estimation results, and convert the calculated SNR into a predetermined number of CQI bits to calculate the UE-specific CQI.

When it becomes time to calculate a precoding matrix index (PMI), the channel state information producer may select one of a predetermined number of plural switched beams and generate selection information on the selected switched beam (a switched beam index (SBI)).

The channel state information producer may construct a covariance matrix using the cell-specific channel estimation results, eigen-decompose the covariance matrix to select an eigen vector having the largest eigen value, and then select the switched beam having the highest degree of correlation with the selected eigen vector from among the plurality of switched beams.

The channel state information producer may calculate SNRs of the received signal by multiplying the cell-specific channel estimation results and vectors of the respective switched beams, and then select the switched beam having the largest SNR.

In other example embodiments, an apparatus for receiving channel state information includes: a scheduler configured to determine code rates and modulation schemes of respective UEs on the basis of at least one of cell-specific CQIs, UE-specific CQIs, and switched beam selection information transmitted from the respective UEs, determine positions of subcarriers in which UE-specific reference signals will be inserted, and determine beamforming weight vectors of the respective UEs; a channel encoding unit configured to channel-encode bit streams according to the determined code rates; a modulation unit configured to modulate the channel-encoded data according to the determined modulation schemes; a resource mapping unit configured to insert UE-specific reference signals of the respective UEs according to the determined positions of the subcarriers; and a beamforming unit configured to generate antenna-specific signals by applying the determined beamforming weight vectors of the respective UEs to signals provided by the resource mapping unit, and then allocate cell-specific reference signals to the antenna-specific signals.

When only a cell-specific CQI and switched beam selection information are transmitted from a specific UE, the scheduler may determine a modulation scheme and code rate in consideration of a beamforming gain based on a beamforming weight vector and a cell-specific CQI.

When the cell-specific CQI, a UE-specific CQI, and the switched beam selection information are transmitted from the specific UE, the scheduler may determine a modulation scheme and code rate in consideration of the beamforming gain and an interference cancellation gain.

When the apparatus operates in a dual-layer beamforming mode as a downlink transmission mode and in a multi-user MIMO (MU-MIMO) mode, the scheduler may select a transmission target UE in consideration of the switched beam selection information transmitted from the plurality of UEs.

The scheduler may determine vectors indicated by SBIs, which are the switched beam selection information transmitted from the respective UEs, or precoding vectors having the highest degrees of correlation with the vectors indicated by the SBIs as the beamforming weight vectors.

In other example embodiments, a method of transmitting and receiving channel state information includes: when it becomes time to calculate a CQI, extracting, at a channel state information transmitting apparatus, at least one of a cell-specific reference signal and a UE-specific reference signal from a received signal to estimate a downlink channel; calculating, at the channel state information transmitting apparatus, at least one of a cell-specific CQI and UE-specific CQI on the basis of the channel estimation results; when it becomes time to calculate a PMI, selecting, at the channel state information transmitting apparatus, a predetermined switched beam from among a predetermined number of plural switched beams; and transmitting, at the channel state information transmitting apparatus, at least one of the cell-specific CQI, the UE-specific CQI, and switched beam selection information to a channel state information receiving apparatus.

Estimating the downlink channel may include: when a downlink transmission mode is a beamforming mode, extracting the UE-specific reference signal from every four subcarriers in a frequency axis direction of a resource block (RB) region to which physical downlink shared channel (PDSCH) resources of a downlink subframe are allocated, and when the downlink transmission mode is a dual-layer beamforming mode, extracting the UE-specific reference signal from every five subcarriers in the frequency axis direction of the RB region to which the PDSCH resources of the downlink subframe are allocated; and estimating the downlink channel on the basis of the extracted UE-specific reference signal.

Calculating the at least one of the cell-specific CQI and UE-specific CQI may include: when it becomes the time to calculate the CQI, calculating an SNR of the received signal using the channel estimation results obtained on the basis of the cell-specific reference signal; and calculating the cell-specific CQI by converting the calculated SNR into a predetermined number of CQI bits.

Calculating the at least one of the cell-specific CQI and UE-specific CQI may include: when it becomes the time to calculate the CQI, calculating an SNR of the received signal using the channel estimation results obtained on the basis of the UE-specific reference signal; and calculating the UE-specific CQI by converting the calculated SNR into a predetermined number of CQI bits.

Selecting the predetermined switched beam from among the plurality of switched beams may include constructing a covariance matrix using the cell-specific channel estimation results obtained on the basis of the cell-specific reference signal, eigen-decomposing the covariance matrix to select an eigen vector having the largest eigen value, and then selecting the switched beam having the highest degree of correlation with the selected eigen vector from among the plurality of switched beams.

Selecting the predetermined switched beam from among the plurality of switched beams may include calculating SNRs of the received signal by multiplying the cell-specific channel estimation results obtained on the basis of the cell-specific reference signal and vectors of the respective switched beams, and then selecting the switched beam having the largest SNR.

The method may further include a scheduling step of determining, at the channel state information receiving apparatus, at least one of a code rate, a modulation scheme, a position of a subcarrier in which the UE-specific reference signal will be inserted, and a beamforming weight vector on the basis of the cell-specific CQI, the UE-specific CQI, and the switched beam selection information transmitted from the channel state information transmitting apparatus.

The scheduling step may include selecting vectors indicated by SBIs, which are the switched beam selection information transmitted from the plurality of channel state information transmitting apparatus, or precoding vectors having the highest degrees of correlation with the vectors indicated by the SBIs as the beamforming weight vectors.

### BRIEF DESCRIPTION OF DRAWINGS

Example embodiments of the present invention will become more apparent by describing in detail example embodiments of the present invention with reference to the accompanying drawings, in which:

FIGS. 1 and 2 illustrate downlink subframe structures applied to a method of transmitting and receiving channel state information according to an example embodiment of the present invention;

FIG. 3 is a block diagram of an apparatus for transmitting channel state information according to an example embodiment of the present invention;

FIG. 4 is a flowchart illustrating a method of producing channel state information according to an example embodiment of the present invention;

FIG. 5 is a conceptual diagram illustrating a method of selecting a switched beam in a channel state information production process illustrated in FIG. 4; and

FIG. 6 is a block diagram of an apparatus for receiving channel state information according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), mobile terminal (MT), user equipment (UE), user terminal (UT), wireless terminal, access terminal (AT), subscriber unit, subscriber station (SS), wireless device, wireless communication device, wireless transmit/receive unit (WTRU), moving node, mobile, or other terms.

The term “base station” used herein generally denotes a fixed point communicating with a UE, and may be referred to as a Node-B, evolved Node-B (eNB), base transceiver system (BTS), access point (AP), and other terms.

Hereinafter, example embodiments of the present invention will be described in detail with reference to the appended drawings. Like numbers refer to like elements throughout the description of the figures, and the description of the same component will not be reiterated.

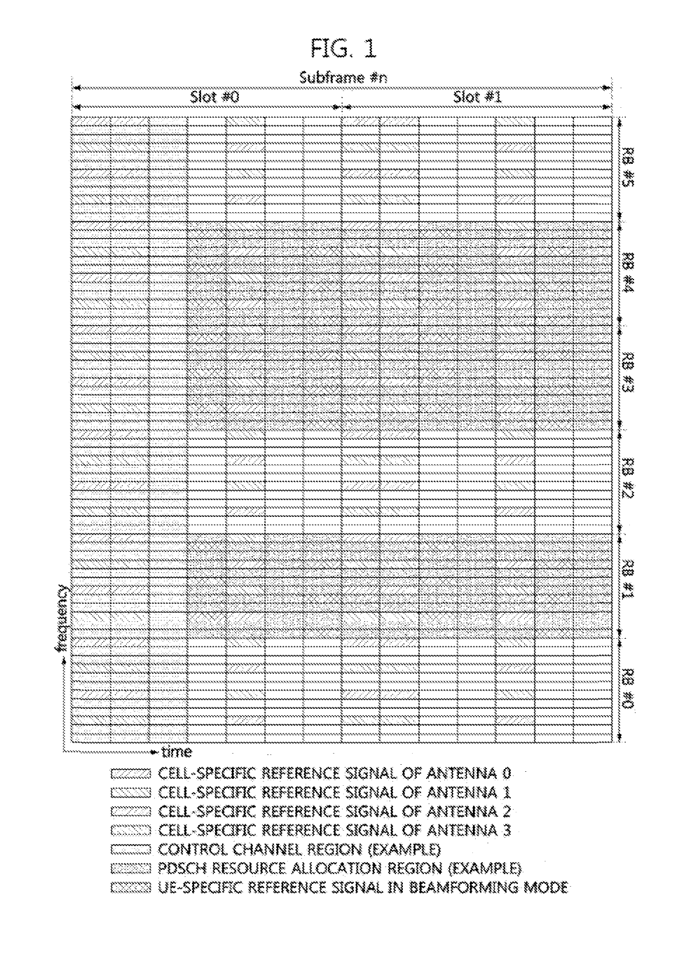

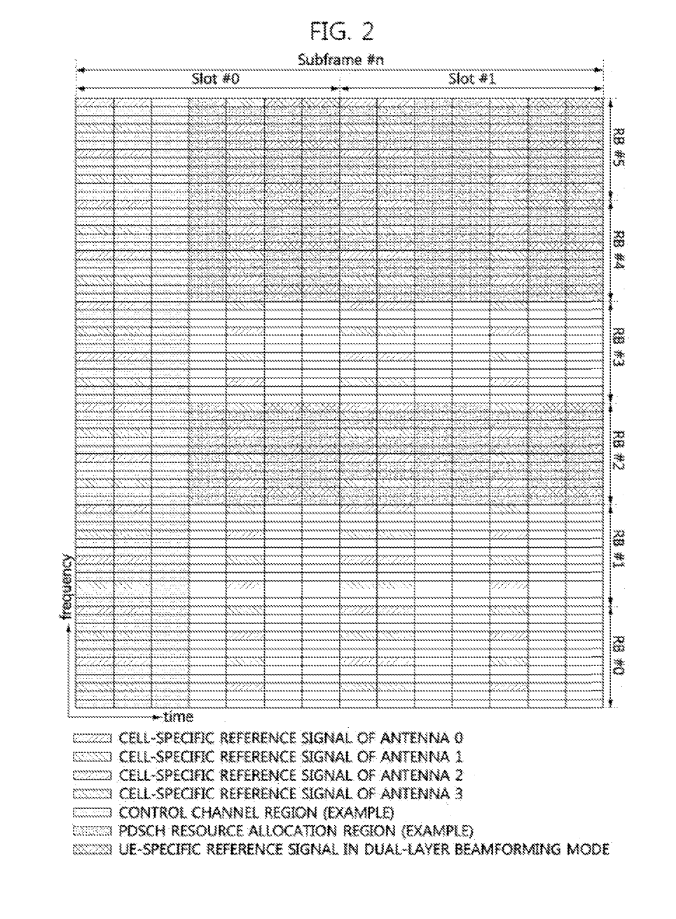

FIGS. 1 and 2 illustrate downlink subframe structures applied to a method of transmitting and receiving channel state information according to an example embodiment of the present invention. FIG. 1 illustrates a subframe structure applied to downlink transmission mode 7 (beamforming mode) of a Third Generation Partnership Project (3GPP) Long Term Evolution (LTE) system, and FIG. 2 illustrates a subframe structure applied to downlink transmission mode 8 (dual-layer beamforming mode) of a 3GPP LTE system.

Referring to FIG. 1, a system bandwidth of a downlink subframe consists of six resource blocks (RBs), and one RB consists of 12 subcarriers. In an LTE system, one RB may have a bandwidth of 180 kHZ. The system bandwidth may consist of a maximum of 110 RBs, and in this case, becomes 20 MHz. Also, when a normal cyclic prefix (CP) is applied, one subframe includes 14 orthogonal frequency division multiplexing (OFDM) symbols in a time axis direction.

When the maximum number of transmitter antennas is four, a cell-specific reference signal is allocated to every six subcarriers in a frequency axis direction of the downlink subframe.

A UE-specific reference signal is allocated to every four subcarriers in the frequency axis direction in only an RB region to which physical downlink shared channel (PDSCH) resources are allocated, as illustrated in FIG. 1.

Referring to FIG. 2, in the dual-layer beamforming mode that is downlink transmission mode 8, a cell-specific reference signal is allocated in the same way as illustrated in FIG. 1.

A UE-specific reference signal is allocated to every five subcarriers in the frequency axis direction, and two UE-specific reference signals are allocated adjacent to each other in the time axis direction by OFDM. Thus, operation may be performed in a multi-user multiple input multiple output (MU-MIMO) scheme of transmitting data to two UEs using the same frequency and time resources, or a single user MIMO (SU-MIMO) scheme of transmitting two data streams to one UE.

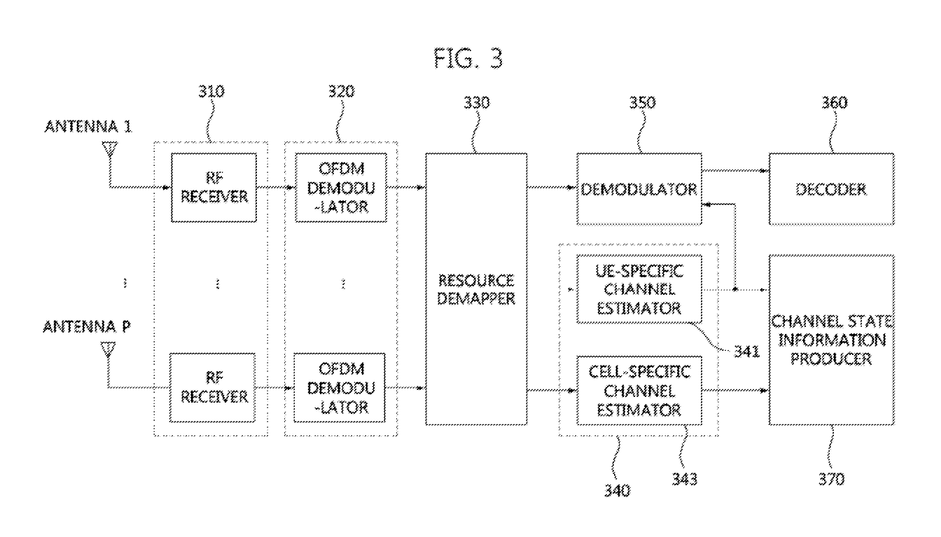

FIG. 3 is a block diagram of an apparatus for transmitting channel state information according to an example embodiment of the present invention. The apparatus for transmitting channel state information may be a UE having a plurality of antennas.

Referring to FIG. 3, the apparatus for transmitting channel state information (referred to as “UE” below) may include a radio frequency (RF) receiving unit 310, an OFDM demodulation unit 320, a resource demapper 330, a channel estimation unit 340, a demodulator 350, a decoder 360, and a channel state information producer 370.

The RF receiving unit 310 samples signals respectively received through a plurality of antennas, and converts the received signals to baseband. To this end, the RF receiving unit 310 may include RF receivers numbering the same (P) as the antennas, and each RF receiver converts an RF signal received through an antenna connected with the RF receiver itself into a baseband signal and provides the baseband signal to the corresponding OFDM demodulation unit.

The OFDM demodulation unit 320 may include OFDM demodulators numbering the same as the antennas and the RF receivers, and each OFDM demodulator performs OFDM demodulation on a baseband signal provided by the corresponding RF receiver.

The resource demapper 330 receives the OFDM-demodulated signal from the OFDM demodulation unit 320, and extracts data, a UE-specific reference signal, and a cell-specific reference signal from the corresponding subcarrier positions of the OFDM-demodulated signal. At this time, the resource demapper 330 may extract a UE-specific reference signal allocated to every four subcarriers in the frequency axis direction of a downlink subframe as shown in FIG. 1 when a downlink transmission mode is the beamforming mode, and may extract the corresponding UE-specific reference signal from among UE-specific signals allocated adjacent to each other in the time axis direction of a downlink subframe to every five subcarriers in the frequency axis direction of the downlink subframe as shown in FIG. 2 when a downlink transmission mode is the dual-layer beamforming mode.

The channel estimation unit 340 includes a UE-specific channel estimator 341 that estimates a channel between a base station and the UE on the basis of the UE-specific reference signal provided by the resource demapper 330, and a cell-specific channel estimator 343 that estimates the channel between the base station and the UE on the basis of the cell-specific reference signal provided by the resource demapper 330.

The demodulator 350 demodulates data provided by the resource demapper 330 using channel estimation information provided by the UE-specific channel estimator 341.

The decoder 360 decodes the demodulated data provided by the demodulator 350, thereby restoring data.

The channel state information producer 370 produces channel state information on the basis of UE-specific channel estimation information and cell-specific channel estimation information provided by the channel estimation unit 340. The produced channel state information is fed back to the base station. Here, the channel state information may include a cell-specific channel quality indicator (CQI) produced on the basis of the cell-specific channel state information, a UE-specific CQI produced on the basis of the UE-specific channel state information, and information on a switched beam selected from among a plurality of switched beams.

Specifically, the channel state information producer 370 calculates a signal-to-noise ratio (SNR) of the received signal using the channel estimation results provided by the cell-specific channel estimator 343, and then converts the calculated SNR into a CQI (cell-specific CQI) having a predetermined number of bits.

Also, the channel state information producer 370 calculates an SNR of the received signal using the channel estimation results provided by the UE-specific channel estimator 341, and then converts the calculated SNR into a CQI (UE-specific CQI).

Further, the channel state information producer 370 selects one of a predetermined number of switched beams, and generates information on the selected switched beam (a switched beam index (SBI)). The switched beam information is fed back to the base station.

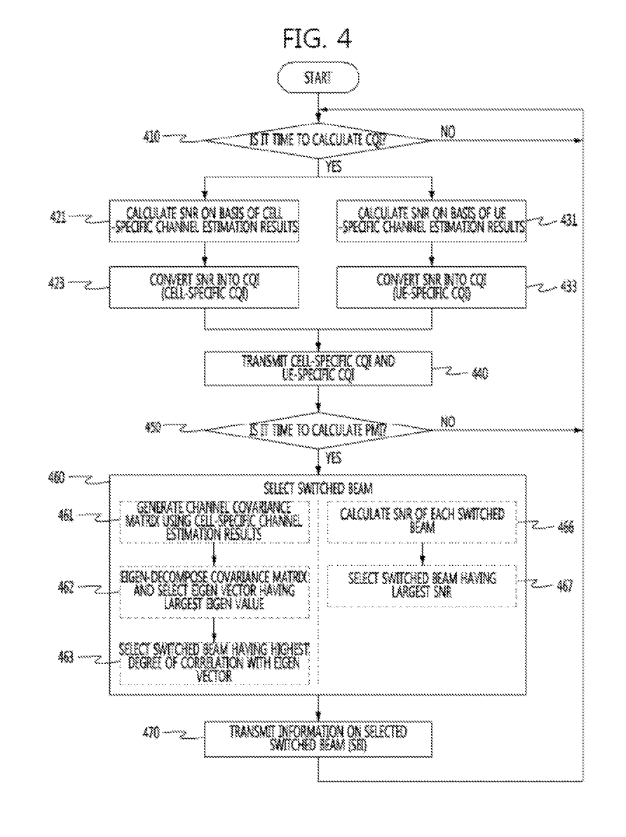

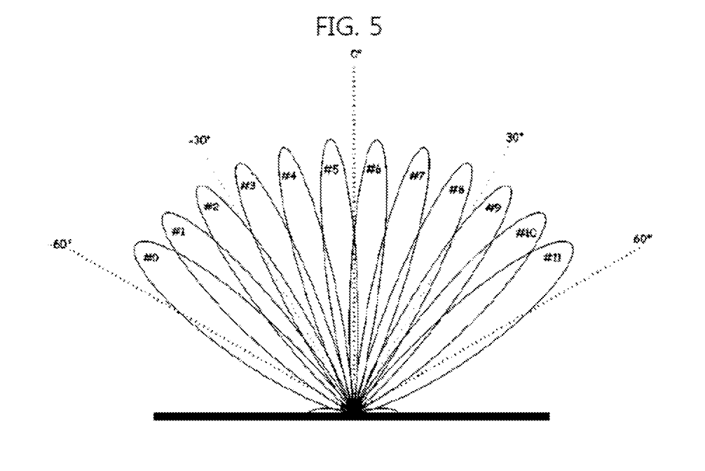

FIG. 4 is a flowchart illustrating a method of producing channel state information according to an example embodiment of the present invention, the flowchart specifically illustrating a channel state information production process performed by the channel state information producer 370 of the apparatus for transmitting channel state information (or UE) shown in FIG. 3. Also, FIG. 5 is a conceptual diagram illustrating a method of selecting a switched beam in the channel state information production process illustrated in FIG. 4.

Referring to FIGS. 4 and 5, the UE first determines whether it is time to calculate a CQI (step 410). The time to calculate a CQI may be determined according to a CQI reporting method, and the CQI reporting method may be performed periodically or aperiodically according to determination of a base station. For example, when CQI reporting is periodically performed and a frequency division duplex (FDD) scheme is used, a CQI reporting period may be one of 2, 5, 10, 20, 32, 40, 64, 80, 128 and 160 ms.

When it is determined in step 410 that it is the time to calculate a CQI, the UE calculates an SNR of a received signal using channel estimation results obtained on the basis of a cell-specific reference signal (step 421), and converts the calculated SNR into a CQI having a predetermined number of bits (step 423). Here, the UE may calculate the SNR of the received signal on the assumption that a downlink transmission mode is a transmit diversity mode, and the CQI bits may consist of, for example, four bits. A CQI obtained on the basis of a cell-specific reference signal will be referred to as a cell-specific CQI below.

Also, the UE calculates an SNR of the received signal using channel estimation results obtained on the basis of a UE-specific reference signal and including a beamforming weight vector (step 431), and converts the calculated SNR into a CQI (step 433). Here, the UE may calculate the SNR of the received signal on the assumption that the downlink transmission mode is a beamforming transmission mode. A CQI obtained on the basis of a UE-specific reference signal as mentioned above will be referred to as a UE-specific CQI below.

Subsequently, the UE transmits the cell-specific CQI and/or the UE-specific CQI obtained through step 423 and step 433 to the base station (step 440).

FIG. 4 illustrates an example in which step 421 and step 423 are performed at the same time as step 431 and step 433. However, step 421 and step 423 may be performed prior to step 431 and step 433, and vice versa.

A difference between the cell-specific CQI and the UE-specific CQI becomes a beamforming gain.

Also, the UE determines whether it is time to calculate a precoding matrix index (PMI) (step 450). Here, the time to calculate a PMI may be determined according to a PMI reporting method, and the PMI reporting method may be performed periodically or aperiodically according to determination of a base station.

In an example embodiment of the present invention, when it becomes the time to calculate a PMI while the UE operates in downlink transmission mode 7 or 8, the UE selects one of a predetermined number of switched beams without calculating a PMI (step 460), and transmits selected SBI information to the base station (step 470).

For example, when the base station has eight array antennas, a space between −60 degrees and 60 degrees may be divided into 12 spaces and configured as switched beams. The number of switched beams may be determined according to the number of PMI bits. For example, when a PMI consists of four bits, 16 switched beams may be configured. Here, a vector denoting a switched beam becomes an array response vector in each direction.

When the number of array antennas of the base station is P, a distance between antennas is d λ, and the space between −60 degrees and 60 degrees is configured as B switched beams, a vector denoting each switched beam may be expressed as shown in Equation 1.

$$\begin{matrix}{\underline{w}}_{i} [ \begin{matrix}1 & {e}^{- j 2 π d sin ( {θ}_{i} )} & … & {e}^{- j 2 π ( P - 1 ) d sin ( {θ}_{i} )}\end{matrix} ] & [ Equation 1 ] \\ {θ}_{i} = \frac{π}{180} \cdot ( \frac{60 - ( - 60 )}{B} ) \cdot i ( i = 0 , 1 , … , B - 1 ) & \end{matrix}$$

In Equation 1, i denotes an index of a switched beam, and θᵢ denotes a phase of an i-th switched beam.

To select a switched beam that expresses spatial information on the UE best from among the B switched beams, the two following methods may be used.

Specifically, a covariance matrix of a channel is constructed using the cell-specific channel estimation results (step 461), and then the covariance matrix is eigen-decomposed to select an eigen vector having the largest eigen value (step 462). Then, the degrees of correlation between the selected eigen vector and the respective B switched beams are calculated, and a switched beam having the highest degree of correlation is selected (step 463).

Otherwise, the cell-specific channel estimation results are multiplied by vectors of the respective switched beams to calculate SNRs of the received signal (step 466), and then a switched beam having the largest SNR of the received signal is selected (step 467). An index of the switched beam selected using one of the above-described two methods will be referred to as an SBI below.

The UE feeds back at least one of the cell-specific CQI, UE-specific CQI, and SBI produced as described above to a base station, and a scheduler of the base station utilizes the fed back information according to the downlink transmission mode.

FIG. 4 illustrates an example in which step 410 to step 440, which are processes of obtaining a cell-specific CQI and UE-specific CQI, are performed first, and then step 450 and step 470, which are processes of obtaining SBI information, are performed. However, in another example embodiment of the present invention, step 450 and step 470, which are processes of obtaining SBI information, may be performed first, and then step 410 to step 440, which are processes of obtaining a cell-specific CQI and UE-specific CQI, may be performed.

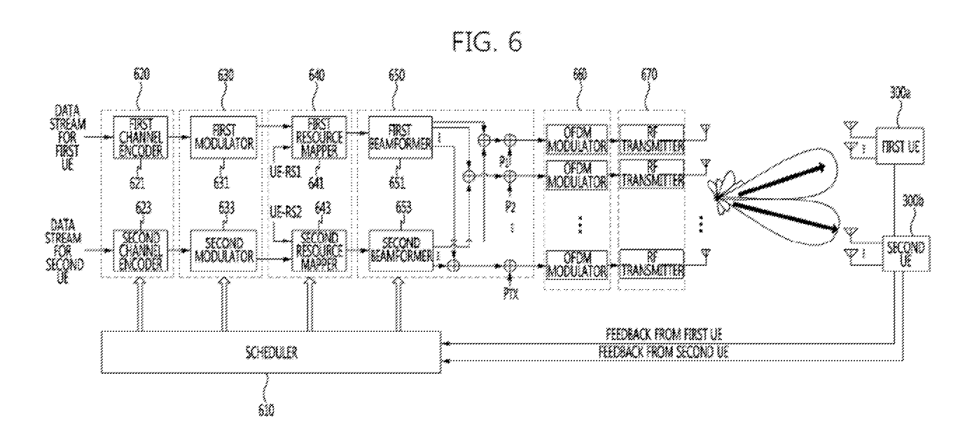

FIG. 6 is a block diagram of an apparatus for receiving channel state information according to an example embodiment of the present invention. The apparatus for receiving channel state information may be a base station that performs beamforming and channel adaptive transmission on the basis of channel state information fed back from a plurality of UEs.

As an example, the apparatus for receiving channel state information shown in FIG. 6 has a plurality of antennas, and operates in the dual-layer beamforming mode, which is downlink transmission mode 8 of LTE systems, to transmit different data streams to two different UEs (i.e., a first UE and a second UE), respectively.

Referring to FIG. 6, the apparatus for receiving channel state information (referred to as a base station below) may include a scheduler 610, an encoding unit 620, a modulation unit 630, a resource mapping unit 640, a beamforming unit 650, an OFDM modulation unit 660, and an RF transmission unit 670.

The scheduler 610 determines a channel code rate and modulation scheme for channel adaptive transmission of data streams to be transmitted to respective UEs 300a and 300b on the basis of at least one type of information among cell-specific CQIs, UE-specific CQIs, and SBIs, which are information fed back from the first UE 300a and the second UE 300b. Here, when a cell-specific CQI and SBI are transmitted from a specific UE but a UE-specific CQI is not transmitted, the scheduler 610 may determine a modulation scheme and code rate in consideration of a beamforming gain based on a beamforming weight vector and the cell-specific CQI only. On the other hand, when a cell-specific CQI, SBI, and UE-specific CQI are all transmitted from a UE, the scheduler 610 may determine a modulation scheme and code rate in consideration of an obtainable interference cancellation gain, etc. in addition to a beamforming gain.

Also, the scheduler 610 determines a subcarrier position to which a modulated signal will be mapped, and a subcarrier position in which a UE-specific reference signal will be inserted, and determines beamforming weight vectors of the respective UEs 300a and 300b on the basis of the pieces of information respectively fed back from the first UE 300a and the second UE 300b. Here, using the SBIs transmitted from the respective UEs 300a and 300b, the scheduler 610 may determine vectors indicating the corresponding switched beams as beamforming weight vectors, or precoding vectors having the highest degrees of correlation with the vectors indicating the corresponding switched beams as beamforming weight vectors.

Further, when the downlink transmission mode is the dual-layer beamforming mode and an MU-MIMO mode is used, the scheduler 610 may determine two UEs having the largest SBI difference as signal transmission targets, to which signals will be transmitted on the same subcarrier at the same time, in consideration of SBIs transmitted from a plurality of UEs.

The encoding unit 620 may include a first channel encoder 621 for encoding a data stream to be transmitted to the first UE 300a and a second channel encoder 623 for encoding a data stream to be transmitted to the second UE 300b. The first channel encoder 621 and the second channel encoder 623 perform channel encoding according to the code rate determined by the scheduler 610.

The modulation unit 630 may include a first modulator 631 and a second modulator 633. The first modulator 631 and the second modulator 633 modulate pieces of encoded data respectively provided by the first channel encoder 621 and the second channel encoder 623. Here, the first modulator 631 and the second modulator 633 may perform quadrature amplitude modulation (QAM).

The resource mapping unit 640 may include a first resource mapper 641 and a second resource mapper 643. The first resource mapper 641 maps a modulated signal provided by the first modulator 631 according to the subcarrier position determined by the scheduler 610, and inserts UE-specific reference signal 1 UE-RS1. Also, the second resource mapper 643 maps a modulated signal provided by the second modulator 633 according to the subcarrier position determined by the scheduler 610, and inserts UE-specific reference signal 2 UE-RS2.

As shown in FIG. 2, each of UE-specific reference signal 1 UE-RS1 and UE-specific reference signal 2 UE-RS2 may be allocated to every five subcarriers in a frequency axis direction of a downlink subframe, and the two UE-specific reference signals may be allocated adjacent to each other in a time axis direction by OFDM.

The beamforming unit 650 may include a first beamformer 651 and a second beamformer 653. The first beamformer 651 multiplies the signal mapped by the first resource mapper 641 by the beamforming weight vector of the first terminal 300a determined by the scheduler 610, thereby generating antenna-specific signals. Also, the second beamformer 653 multiplies the signal mapped by the second resource mapper 643 by the beamforming weight vector of the second terminal 300b determined by the scheduler 610, thereby generating antenna-specific signals.

Also, the beamforming unit 650 inserts cell-specific reference signals P₁, P₂, . . . , P_{TX} in the antenna-specific signals generated as mentioned above, respectively. As shown in FIGS. 1 and 2, each of the cell-specific reference signals may be allocated to every six subcarriers in the frequency axis direction of the downlink subframe, and the cell-specific reference signals may be allocated according to the respective antennas.

The OFDM modulation unit 660 may include OFDM modulators numbering the same as the antennas, and each OFDM modulator performs OFDM modulation on a signal provided by the corresponding beamformer.

The RF transmission unit 670 may include RF transmitters numbering the same as the antennas. Each RF transmitter converts a signal provided by the corresponding OFDM modulator into an analog signal, amplifies the analog signal to convert the analog signal into a signal in an RF band, and then transmits the signal through the corresponding antenna.

According to the above-described apparatus and method for transmitting and receiving channel state information, a UE operating in a beamforming mode selects a switched beam having the best SNR or the highest degree of correlation with eigen vector of a channel covariance matrix among a predetermined number of switched beams using a cell-specific reference signal, and then transmits information on the selected switched beam to a base station. Also, the UE transmits a cell-specific CQI calculated using the cell-specific reference signal on the assumption that a downlink transmission mode is a transmit diversity mode and/or a UE-specific CQI calculated on the assumption that the downlink transmission mode is a beamforming transmission mode to the base station.

The base station determines a beamforming weight vector on the basis of switched beam selection information, the cell-specific CQI, and the UE-specific CQI transmitted from the UE, and determines a code rate and modulation scheme.

Consequently, it is possible to efficiently perform channel adaptive transmission and beamforming-mode transmission in consideration of an actually reflected beamforming gain and interference cancellation gain. Also, switched beam selection information transmitted from the UE can be used as location information on the UE.

While the example embodiments of the present invention and their advantages have been described in detail, it should be understood that various changes, substitutions and alterations may be made herein without departing from the scope of the invention.

What is claimed is:

1. An apparatus for transmitting channel state information, comprising:
an orthogonal frequency division multiplexing (OFDM) demodulation unit configured to perform OFDM demodulation on a received signal;
a resource demapper configured to extract at least one of data, a user equipment (UE)-specific reference signal, and a cell-specific reference signal from the OFDM-demodulated signal;
a channel estimation unit configured to estimate a downlink channel on the basis of at least one of the UE-specific reference signal and the cell-specific reference signal; and
a channel state information producer configured to produce at least one of a cell-specific channel quality indicator (CQI), a UE-specific CQI, and switched beam selection information on the basis of information on the estimated downlink channel.

2. The apparatus of claim 1, wherein the channel estimation unit includes:
a UE-specific channel estimator configured to provide the channel estimation unit with UE-specific channel estimation results obtained by estimating the downlink channel on the basis of the UE-specific reference signal; and
a cell-specific channel estimator configured to provide the channel estimation unit with cell-specific channel estimation results obtained by estimating the downlink channel on the basis of the cell-specific reference signal.

3. The apparatus of claim 2, wherein, when it becomes time to calculate a CQI, the channel state information producer calculates a signal-to-noise ratio (SNR) of the received signal using the cell-specific channel estimation results, and converts the calculated SNR into a predetermined number of CQI bits to calculate the cell-specific CQI.

4. The apparatus of claim 2, wherein, when it becomes time to calculate a CQI, the channel state information producer calculates a signal-to-noise ratio (SNR) of the received signal using the UE-specific channel estimation results, and converts the calculated SNR into a predetermined number of CQI bits to calculate the UE-specific CQI.

5. The apparatus of claim 2, wherein, when it becomes time to calculate a precoding matrix index (PMI), the channel state information producer selects one of a predetermined number of plural switched beams and generates selection information on the selected switched beam (a switched beam index (SBI)).

6. The apparatus of claim 5, wherein the channel state information producer constructs a covariance matrix using the cell-specific channel estimation results, eigen-decomposes the covariance matrix to select an eigen vector having a largest eigen value, and then selects the switched beam having a highest degree of correlation with the selected eigen vector from among the plurality of switched beams.

7. The apparatus of claim 5, wherein the channel state information producer calculates signal-to-noise ratios (SNRs) of the received signal by multiplying the cell-specific channel estimation results and vectors of the respective switched beams, and then selects the switched beam having a largest SNR.

8. An apparatus for receiving channel state information, comprising:
a scheduler configured to determine code rates and modulation schemes of respective user equipments (UEs) on the basis of at least one of cell-specific channel quality indicators (CQIs), UE-specific CQIs, and switched beam selection information transmitted from the respective UEs, determine positions of subcarriers in which UE-specific reference signals will be inserted, and determine beamforming weight vectors of the respective UEs;
a channel encoding unit configured to channel-encode bit streams according to the determined code rates;
a modulation unit configured to modulate the channel-encoded data according to the determined modulation schemes;
a resource mapping unit configured to insert UE-specific reference signals of the respective UEs according to the determined positions of the subcarriers; and
a beamforming unit configured to generate antenna-specific signals by applying the determined beamforming weight vectors of the respective UEs to signals provided by the resource mapping unit, and then allocate cell-specific reference signals to the antenna-specific signals.

9. The apparatus of claim 8, wherein, when only a cell-specific CQI and switched beam selection information are transmitted from a specific UE, the scheduler determines a modulation scheme and code rate in consideration of a beamforming gain based on a beamforming weight vector and a cell-specific CQI, and
when the cell-specific CQI, a UE-specific CQI, and the switched beam selection information are transmitted from the specific UE, the scheduler determines a modulation scheme and code rate in consideration of the beamforming gain and an interference cancellation gain.

10. The apparatus of claim 8, wherein, when the apparatus operates in a dual-layer beamforming mode as a downlink transmission mode and in a multi-user multiple input multiple output (MU-MIMO) mode, the scheduler selects transmission target UEs in consideration of the switched beam selection information transmitted from the plurality of UEs.

11. The apparatus of claim 8, wherein the scheduler determines vectors indicated by switched beam indices (SBIs), which are the switched beam selection information transmitted from the respective UEs, or precoding vectors having highest degrees of correlation with the vectors indicated by the SBIs as the beamforming weight vectors.

12. The apparatus of claim 8, wherein, when a downlink transmission mode is a beamforming mode, the resource mapping unit inserts the UE-specific reference signals in every four subcarriers in a frequency axis direction of a resource block (RB) region to which physical downlink shared channel (PDSCH) resources of a downlink subframe are allocated, and
when the downlink transmission mode is a dual-layer beamforming mode, the resource mapping unit inserts the UE-specific reference signals of the respective UEs in every five subcarriers in the frequency axis direction of the RB region to which the PDSCH resources of the downlink subframe are allocated.

13. A method of transmitting and receiving channel state information, comprising:
when it becomes time to calculate a channel quality indicator (CQI), extracting, at a channel state information transmitting apparatus, at least one of a cell-specific reference signal and a user equipment (UE)-specific reference signal from a received signal to estimate a downlink channel;
calculating, at the channel state information transmitting apparatus, at least one of a cell-specific CQI and UE-specific CQI on the basis of the channel estimation results;
when it becomes time to calculate a precoding matrix index (PMI), selecting, at the channel state information transmitting apparatus, a predetermined switched beam from among a predetermined number of plural switched beams; and
transmitting, at the channel state information transmitting apparatus, at least one of the cell-specific CQI, the UE-specific CQI, and switched beam selection information to a channel state information receiving apparatus.

14. The method of claim 13, wherein estimating the downlink channel includes:
when a downlink transmission mode is a beamforming mode, extracting the UE-specific reference signal from every four subcarriers in a frequency axis direction of a resource block (RB) region to which physical downlink shared channel (PDSCH) resources of a downlink subframe are allocated, and when the downlink transmission mode is a dual-layer beamforming mode, extracting the UE-specific reference signal from every five subcarriers in the frequency axis direction of the RB region to which the PDSCH resources of the downlink subframe are allocated; and
estimating the downlink channel on the basis of the extracted UE-specific reference signal.

15. The method of claim 13, wherein calculating the at least one of the cell-specific CQI and UE-specific CQI includes:
when it becomes the time to calculate the CQI, calculating a signal-to-noise ratio (SNR) of the received signal using the channel estimation results obtained on the basis of the cell-specific reference signal; and
calculating the cell-specific CQI by converting the calculated SNR into a predetermined number of CQI bits.

16. The method of claim 13, wherein calculating the at least one of the cell-specific CQI and UE-specific CQI includes:
when it becomes the time to calculate the CQI, calculating a signal-to-noise ratio (SNR) of the received signal using the channel estimation results obtained on the basis of the UE-specific reference signal; and
calculating the UE-specific CQI by converting the calculated SNR into a predetermined number of CQI bits.

17. The method of claim 13, wherein selecting the predetermined switched beam from among the plurality of switched beams includes constructing a covariance matrix using the cell-specific channel estimation results obtained on the basis of the cell-specific reference signal, eigen-decomposing the covariance matrix to select an eigen vector having a largest eigen value, and then selecting the switched beam having a highest degree of correlation with the selected eigen vector from among the plurality of switched beams.

18. The method of claim 13, wherein selecting the predetermined switched beam from among the plurality of switched beams includes calculating signal-to-noise ratios (SNRs) of the received signal by multiplying the cell-specific channel estimation results obtained on the basis of the cell-specific reference signal and vectors of the respective switched beams, and then selecting the switched beam having a largest SNR.

19. The method of claim 13, further comprising a scheduling step of determining, at the channel state information receiving apparatus, at least one of a code rate, a modulation scheme, a position of a subcarrier in which the UE-specific reference signal will be inserted, and a beamforming weight vector on the basis of the cell-specific CQI, the UE-specific CQI, and the switched beam selection information transmitted from the channel state information transmitting apparatus.

20. The method of claim 19, wherein the scheduling step includes selecting vectors indicated by switched beam indices (SBIs), which are the switched beam selection information transmitted from the plurality of channel state information transmitting apparatus, or precoding vectors having highest degrees of correlation with the vectors indicated by the SBIs as the beamforming weight vectors.
